(19) United States
(12) Patent Application Publication
(10) Pub. No.: US 2014/0043576 A1
(43) Pub. Date: Feb. 13, 2014

(54) LIQUID CRYSTAL DISPLAY PANEL AND LIQUID CRYSTAL DISPLAY DEVICE

(71) Applicants: Yuki Kawashima, Osaka-shi (JP); Yasutoshi Tasaka, Osaka-shi (JP); Keiichi Ina, Osaka-shi (JP)

(72) Inventors: Yuki Kawashima, Osaka-shi (JP); Yasutoshi Tasaka, Osaka-shi (JP); Keiichi Ina, Osaka-shi (JP)

(73) Assignee: SHARP KABUSHIKI KAISHA, Osaka-shi, Osaka (JP)

(21) Appl. No.: 14/113,234

(22) PCT Filed: Apr. 18, 2012
(86) PCT No.: PCT/JP2012/060497

§ 371 Date: Oct. 22, 2013

(30) Foreign Application Priority Data
Apr. 25, 2011 (JP) 2011-097539

(51) Int. Cl. G02F 1/1343

(52) U.S. Cl. CPC G02F 1/134309
USPC 349/142

(57) ABSTRACT

A liquid crystal display panel (10) includes: an array substrate (1); a counter substrate (2); a liquid crystal layer (3); and spacer members (4). A plurality of pixels provided on the array substrate (1) include first pixels on which no spacer members (4) are provided and second pixels on which the respective spacer members (4) are provided. First pixel electrodes (20) provided in the respective first pixels each have: a first main part (21a); a second main part (21b); and a plurality of branch parts (22a through 22d) extending, in fixed directions. Second pixel electrodes (30) provided in the respective second pixels each have: a first main part (31a); a second main part (31b); a plurality of branch parts (32a through 32d) extending, in fixed directions; and a region on which a corresponding one of the spacer members (4) is provided and which is a solid electrode.

### TECHNICAL FIELD

The present invention relates to (i) a liquid crystal display panel configured so that an electrode having a fine pattern is provided in each pixel and (ii) a liquid crystal display device including the liquid crystal display panel.

### BACKGROUND ART

At the present day, a liquid crystal display panel is used for a variety of display devices such as computers, mobile phones, and televisions. A liquid crystal display panel includes a liquid crystal layer sandwiched between two glass substrates. Transmissivity of light passing through the liquid crystal layer is controlled by an alignment status of liquid crystals. Between the two glass substrates, cell gap members are provided so as to maintain a distance between the two glass substrates and therefore to maintain a thickness of the liquid crystal layer. An example of the cell gap members is spacer members.

Meanwhile, technologies of recent years are known to control alignment of liquid crystals by forming pixel electrodes in a fine pattern. In such a case, however, spacer members provided in pixels have various effects on the pixel electrodes. This requires close attention to positions of the spacer members.

For example, in a case where spacer members are provided in pixels having fine-patterned pixel electrodes, the spacer members are typically provided at end parts of the pixels. In other words, the spacer members are provided so as not to be in contact with the pixel electrodes. Patent Literature 1, for example, discloses a layout of pixel electrodes in a case where spacer members are provided in pixels. FIG. 10 is a view illustrating the layout of pixels of a conventional liquid crystal display device disclosed in Patent Literature 1. As illustrated in FIG. 10, the layout of pixels 51 included in a liquid crystal display device 50 of Patent Literature 1 is arranged so that pixel electrodes 52, which are provided on respective pixels 51, each have (i) a plurality of long and narrow openings that extend in a column direction and (ii) a region on which (a) no opening is formed and (b) a spacer member 53 is provided.

### CITATION LIST

### Patent Literature

Patent Literature 1
Japanese Patent Application Publication, Tokukai, No. 2010-54649 A (Publication Date: Mar. 11, 2010)

### SUMMARY OF INVENTION

### Technical Problem

However, in a case where spacer members are provided at end parts of pixels, alignment directions of liquid crystals in the vicinity of the spacer members becomes disordered and therefore causes transmissivity of light through the liquid crystals to be lowered. Besides, although the layout of Patent Literature 1 is arranged so that the pixel electrodes 52 formed in a fine pattern are provided so as not to overlap the spacer member 53, there are cases where spacer members 53 need to be provided on pixel electrodes 52. This causes the pixel electrodes 52 to be damaged by pressure of the spacer members 53, and therefore results in pixel defects.

The present invention has been made in view of the problem, and it is an object of the present invention to provide a liquid crystal display panel capable of (i) controlling alignment of liquid crystals with greater stability and (ii) achieving display of excellent quality by preventing pixel defects.

### Solution to Problem

In order to attain the object, a liquid crystal display panel in accordance with an embodiment of the present invention includes: a substrate on which first pixels and second pixels are provided; a counter substrate provided so as to face the substrate; a liquid crystal layer sandwiched between the substrate and the counter substrate; and a plurality of spacer members for maintaining a fixed distance between the substrate and the counter substrate, no spacer member being provided in each of the first pixels, and the first pixels including respective first pixel electrodes, and the plurality of space members being provided in the respective second pixels, and the second pixels including respective second pixel electrodes, the first pixel electrodes each having a first main part provided on a first straight line which connects two end parts of the first pixel electrode via the center part of the first pixel electrode, a second main part provided on a second straight line which is perpendicular to the first straight line and which connects two end parts of the first pixel electrode via the center part of the first pixel electrode, and a plurality of branch parts which (a) are present within regions into which the first pixel electrode is divided by the first main part and the second main part and (b) extend, in respective directions relative to the regions, from at least one of the first main part and the second main part to end parts of the first pixel electrode, the second pixel electrodes each having a first main part provided on a first straight line which connects two end parts of the second pixel electrode via the center part of the second pixel electrode, a second main part provided on a second straight line which is perpendicular to the first straight line and which connects two end parts of the second pixel electrode via the center part of the second pixel electrode, a plurality of branch parts which (I) are present within regions into which the second pixel electrode is divided by the first main part and the second main part and (II) extend, in respective directions relative to the regions, from at least one of the first main part and the second main part to end parts of the second pixel electrode, and a region (A) which includes the center part of the second pixel electrode, (B) which is a solid electrode, and (C) on which a corresponding one of the plurality of spacer members is provided.

According to the liquid crystal display panel thus configured, pixel structures vary, depending on whether or not spacer members are provided in a pixel.

First pixel electrodes provided in respective first pixels each have a plurality of slits therein, and is made up of a first main part, a second main part, and a plurality of branch parts. The first main part is provided on a first straight line that connects end parts of the first pixel electrode via a center part of the first pixel electrode. The second main part is provided on a second straight line that (i) is perpendicular to the first straight line and (ii) connects end parts of the first pixel electrode via the center part of the first pixel electrode. The plurality of branch parts (a) are present within respective regions into which the first pixel electrode is divided by the first main part and the second main part and (b) extend, in respective directions relative to the regions, from at least one of the first main part and the second main part to end parts of the first pixel electrode. In each of the first pixels, alignment of liquid crystal molecules in the vicinity of a pixel electrode having a plurality of slits is controlled by the pixel electrode.

On the other hand, second pixel electrode provided in respective second pixel are similar to the first pixel electrodes provided in the respective first pixels in that a first main part, a second main part, and a plurality of branch parts are formed by presence of a plurality of slits. However, the second pixel electrodes are different from the first pixel electrodes in that each of the second pixel electrodes further includes, as a region on which a spacer member is to be provided, a solid electrode.

For example, in a case where (i) a pixel electrode, which is provided so as to be in contact with a spacer member, is formed in a fine pattern and (ii) the pixel electrode receives, via a corresponding spacer member, a force applied to a counter surface, the pixel electrode will be subject to damages such as electric disconnection. According to the liquid crystal display panel in accordance with the embodiment of the present invention, no spacer member is provided in any first pixel but a spacer member is provided in each second pixel. Note, however, that such a spacer member is provided on a part of each of the second pixel electrodes, which part is a solid electrode. This prevents electric disconnection of each second pixel electrode even when it receives a pressing force via a corresponding spacer member, and therefore makes it possible to maintain reliability of the display panel.

With the liquid crystal display panel in accordance with the embodiment of the present invention, therefore, (i) a more stable control of liquid crystal alignment is possible and (ii) pixel defects can be prevented. This allows excellent display to be realized.

A liquid crystal display device in accordance with the embodiment of the present invention includes the liquid crystal display panel in accordance with the embodiment of the present invention. Therefore, (i) a more stable control of liquid crystal alignment is possible and (ii) pixel defects can be prevented. This makes it possible to provide a display device achieving excellent display.

### Advantageous Effects of Invention

A liquid crystal display panel in accordance with an embodiment of the present invention includes: a substrate on which first pixels and second pixels are provided; a counter substrate provided so as to face the substrate; a liquid crystal layer sandwiched between the substrate and the counter substrate; and a plurality of spacer members for maintaining a fixed distance between the substrate and the counter substrate, no spacer member being provided in each of the first pixels, and the first pixels including respective first pixel electrodes, and the plurality of space members being provided in the respective second pixels, and the second pixels including respective second pixel electrodes, the first pixel electrodes each having a first main part provided on a first straight line which connects two end parts of the first pixel electrode via the center part of the first pixel electrode, a second main part provided on a second straight line which is perpendicular to the first straight line and which connects two end parts of the first pixel electrode via the center part of the first pixel electrode, and a plurality of branch parts which (a) are present within regions into which the first pixel electrode is divided by the first main part and the second main part and (b) extend, in respective directions relative to the regions, from at least one of the first main part and the second main part to end parts of the first pixel electrode, the second pixel electrodes each having a first main part provided on a first straight line which connects two end parts of the second pixel electrode via the center part of the second pixel electrode, a second main part provided on a second straight line which is perpendicular to the first straight line and which connects two end parts of the second pixel electrode via the center part of the second pixel electrode, a plurality of branch parts which (I) are present within regions into which the second pixel electrode is divided by the first main part and the second main part and (II) extend, in respective directions relative to the regions, from at least one of the first main part and the second main part to end parts of the second pixel electrode, and a region (A) which includes the center part of the second pixel electrode, (B) which is a solid electrode, and (C) on which a corresponding one of the plurality of spacer members is provided. Therefore, (A) a more stable control of liquid crystal alignment is possible and (B) pixel defects can be prevented. This allows excellent display to be realized.

Additional objects, features, and strengths of the present invention will be made clear by the description below. Furthermore, the advantages of the present invention will be evident from the following explanation with reference to the drawings.

### BRIEF DESCRIPTION OF DRAWINGS

FIG. 1 is a view illustrating pixel structures of a liquid crystal display panel in accordance with an embodiment of the present invention.

FIG. 2 is a view illustrating structures of a liquid crystal display panel in accordance with the embodiment of the present invention.

FIG. 3 is a view illustrating an alignment direction in a first pixel electrode illustrated in (a) of FIG. 1.

FIG. 4 is a view describing liquid crystal alignment in a region Y defined by a dotted line illustrated in FIG. 3.

FIG. 5 is a view illustrating an alignment status of liquid crystal molecules when the liquid crystal molecules are aligned in a direction of an arrow A illustrated in FIG. 3.

FIG. 6 is a view illustrating an alignment direction in a second pixel electrode illustrated in (b) of FIG. 1.

FIG. 7 is a view illustrating an alignment status of liquid crystal molecules in the vicinity of a spacer member.

FIG. 8 is a view illustrating an alignment direction on a solid electrode.

FIG. 9 is a view illustrating an alignment status of liquid crystal molecules on the solid electrode illustrated in FIG. 8.

FIG. 10 is a view illustrating a layout of pixels in a conventional liquid crystal display device.

### DESCRIPTION OF EMBODIMENTS

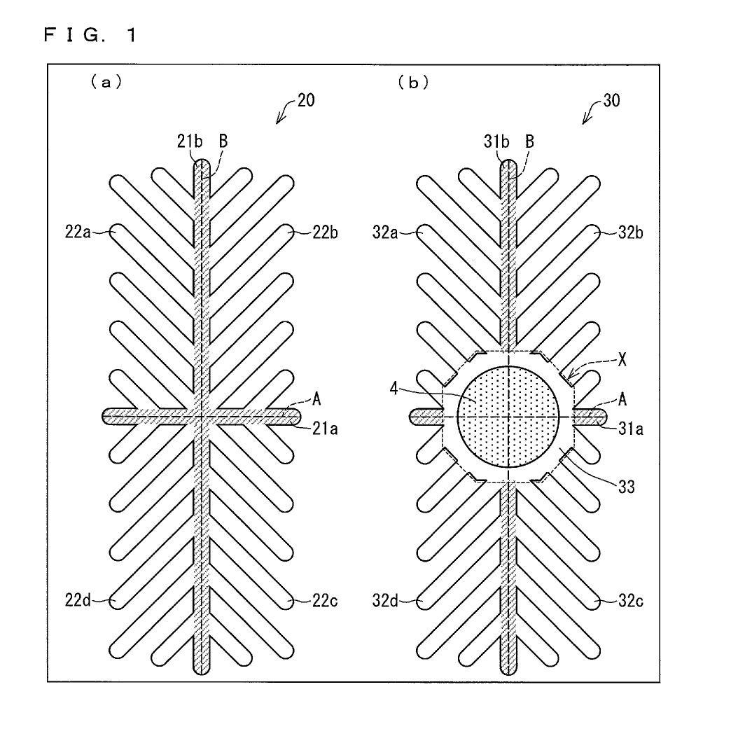

The following description will discuss, with reference to FIGS. 1 through 9, a liquid crystal display panel in accordance with an embodiment of the present invention.

[Configuration of Liquid Crystal Display Panel 10]

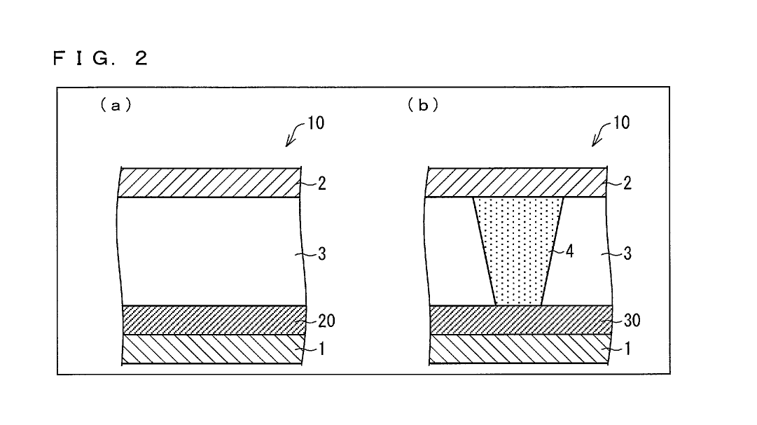

FIG. 2 is a cross-sectional view illustrating a configuration of a liquid crystal display panel 10 in accordance with the embodiment of the present invention. The liquid crystal display panel 10 includes (i) an array substrate (substrate) 1 on which a plurality of pixels are provided, (ii) a counter substrate 2 provided so as to face the array substrate 1, and (iii) a liquid crystal layer 3 sandwiched between the array substrate 1 and the counter substrate 2. The liquid crystal display panel 10 further includes spacer members 4 that maintain a distance between the array substrate 1 and the counter substrate 2. This causes the spacer members 4 to maintain a thickness of the liquid crystal layer 3.

The spacer members 4 are provided in some of the plurality of pixels. (a) of FIG. 2 illustrates a first pixel in which no spacer member 4 is provided. (b) of FIG. 2 illustrates a pixel in which a spacer member 4 is provided. According to the liquid crystal display panel 10, a structure of a pixel varies, depending on whether or not a spacer member 4 is provided in the pixel. This allows for display of excellent quality (detailed described later).

The liquid crystal display panel 10 is of a VA (Vertical Alignment) type. That is, the liquid crystal display panel 10 is configured such that a combination of an alignment film and liquid crystal molecules each having a negative dielectric constant causes (i) each major axis of the liquid crystal molecules to be oriented perpendicularly to the array substrate 1 while no voltage is applied and (ii) the major axis to be tilted and parallel to the array substrate 1 while a voltage is being applied. Furthermore, according to the present embodiment, the liquid crystal display panel 10 controls liquid crystal molecules to be tilted in a plurality of directions in each pixel. Specifically, each pixel is divided into four regions in which liquid crystal molecules have different alignment directions, so that the liquid crystal molecules are tilted in four different directions on the whole. This allows display characteristics to be enhanced.

Elements (such as a TFT (Thin-film transistor)), electrodes, wiring, and the like are provided on a surface of the array substrate 1 which surface is in contact with the liquid crystal layer 3. Specifically, (i) a plurality of scanning lines (gate bus lines) and a plurality of signal lines (source bus lines) are provided on a glass substrate so as to be orthogonal to one another and (ii) pixels, each of which is surrounded by corresponding two adjacent scanning lines and corresponding two adjacent signal lines, are arranged in a matrix manner. Each of the pixels has a TFT and a pixel electrode 20 or 30. A scanning line and a signal line are connected to a gate electrode of the TFT and a source electrode of the TFT, respectively. The pixel electrode 20 or 30 is electrically connected to a drain electrode of the TFT. The TFT is controlled to be switched to an ON or OFF state in response to a scanning signal which is supplied via the scanning line. While the TFT is in an ON state, a display signal is supplied from the signal line to the pixel electrode 20 or 30. A polarizing plate (not illustrated) is further provided on a surface of the array substrate 1 opposite to the surface which is in contact with the liquid crystal layer 3.

According to the liquid crystal display panel 10, a pixel structure varies, depending on whether or not a spacer member 4 is present in the pixel. Specifically, patterns of the pixel electrodes 20 and 30 provided in the respective first and second pixels are different from each other. The patterns of a first pixel electrode 20 (hereinafter also referred to simply as “pixel electrode 20”) provided in the first pixel and a second pixel electrode 30 (hereinafter also referred to simply as “pixel electrode 30”) provided in the second pixel will be described later in detail.

Note that a ratio between first and second pixels of all the pixels is not limited to any particular one. For example, an appropriate ratio need only be determined according to the number and arrangements of the spacer members 4. Note also that each of the pixels provided on the array substrate 1 preferably has a structure of first or second pixel. However, the configuration is not limited to such. In fact, some of the pixels can be different in pixel structure from the pixels each of which has a structure of first or second pixel.

A color filter, electrodes, and the like are provided on a surface of the counter substrate 2 which surface is in contact with the liquid crystal layer 3. According to the present embodiment, the spacer members 4 are incorporated into any positions on the counter substrate 2. A polarizing plate (not illustrated) is provided on a surface of the counter substrate 2 opposite to the surface in contact with the liquid crystal layer 3. The polarizing plate on the counter substrate 2 and the polarizing plate on the array substrate 1 are provided so that their respective transmission axes are orthogonal to each other (crossed Nicols arrangement). This causes the liquid crystal display panel 10, which employs the VA system, to be a normally-black mode panel that produces a black display while no voltage is applied.

The liquid crystal layer 3, which is sandwiched between the array substrate 1 and the counter substrate 2, is a layer including a liquid crystal material. Correctly, the liquid crystal layer 3 is sandwiched between a pair of alignment films by which the liquid crystal molecules are arranged so as to be oriented in a particular direction while no voltage is applied. According to the present embodiment, the alignment of the liquid crystal molecules is controlled by the pixel electrode 20 or 30, which are formed in a predetermined pattern, so that liquid crystal molecules, which are provided in four regions of each pixel, are aligned in respective four directions while a voltage is being applied. Although an angle of liquid crystal molecule alignment while a voltage is being applied is not particularly limited, the liquid crystal molecules preferably make an approximately 45° angle to respective polarization axes of the polarizing plates. This makes it difficult for the polarizing plate on the counter substrate 2 to absorb light which has passed through the liquid crystal layer 3, and therefore allows an increase in transmissivity of the liquid crystal display panel 10.

The spacer members 4 are (i) cell gap members for maintaining a constant distance between the array substrate and the counter substrate 2 and (ii) columnar spacer members generally used in the technical field concerned. A plurality of spacer members 4 are provided in the liquid crystal display panel 10. A spacer member 4 provided in a second pixel of the liquid crystal display panel 10 contributes to a control of the alignment of liquid crystal molecules. Arrangements and the number of spacer members 4 in the liquid crystal display panel 10 are not particularly limited. In a case where a spacer member 4 is provided in a pixel, the spacer member 4 is to be provided in a second pixel. Such a spacer member 4 need only be provided on a location which (i) is of a solid part of a second pixel electrode 30 and (ii) includes a center part of the second pixel electrode 30. The spacer member 4 is preferably provided so that a center axis of the spacer member 4 falls on a part of a second pixel electrode 30, which part is closer to a center part of the second pixel electrode 30 than to any end part of the second pixel electrode 30. This allows for an excellent control of the alignment of the liquid crystal molecules. Note that, although one end part of each of the spacer members 4 is incorporated in the counter substrate 2 according to the present embodiment, the configuration is not limited to such. In fact, the spacer members 4 can be incorporated into the array substrate 1 instead.

[Pixel Structure of Liquid Crystal Display Panel 10]

Patterns of the respective pixel electrodes 20 and 30 in the liquid crystal display panel 10 of the present embodiment will be described below. FIG. 1 is a view illustrating a pixel structure of the liquid crystal display panel 10. (a) of FIG. 1 illustrates a first pixel electrode 20 provided in a first pixel. (b) of FIG. 1 illustrates a second pixel electrode 30 provided in a second pixel.

According to the liquid crystal display panel 10, the liquid crystal molecules are controlled so as to be tilted in four directions in a pixel while a voltage is being applied. To be more specific, (i) alignment of liquid crystal molecules in the first pixel is controlled by a pattern of the pixel electrode 20 and (ii) alignment of liquid crystal molecules in the second pixel is controlled by a pattern of the pixel electrode 30 and by a spacer member 4.

(Pattern of Pixel Electrode 20)

As illustrated in (a) of FIG. 1, the pixel electrode 20 provided in the first pixel has a plurality of slits therein, and is made up of a first main part 21a, a second main part 21b, a plurality of branch parts 22a, a plurality of branch parts 22b, a plurality of branch parts 22c, and a plurality of branch parts 22d. The first main part 21a is provided on a first straight line that connects end parts of the pixel electrode 20 via a center part of the pixel electrode 20 (straight line illustrated by “A” in (a) of FIG. 1). The second main part 21b is provided on a second straight line that (i) is perpendicular to the first straight line and (ii) connects end parts of the pixel electrode 20 via the center part of the pixel electrode 20 (straight line illustrated by “B” in (a) of FIG. 1). The plurality of branch parts 22a through 22d (A) are present within respective four regions into which the pixel electrode 20 is divided by the first main part 21a and the second main part 21b and (B) extend, in respective four directions, from at least one of the first main part 21a and the second main part 21b to end parts of the pixel electrode 20.

Note that slits correspond to regions (i) which are surrounded by outer peripheries of each of the pixel electrodes 20 and 30 and (ii) on which no electrode is provided. The plurality of branch parts 22a through 22d are part of the electrodes, the part being separated by the slits in each of the regions into which the pixel electrode 20 is divided by the first main part 21a and the second main part 21b (such regions are hereinafter also referred to as “segments”).

The plurality of branch parts 22a through 22d extend in the four directions in the respective four segments. For example, the branch parts 22a in an upper left region each extend in an upper left direction with respect to the second straight line, the branch parts 22b in an upper right region each extend in an upper right direction with respect to the second straight line, the branch parts 22c in a lower right region each extend in a lower right direction with respect to the second straight line, and the branch parts 22d in a lower left region each extend in a lower left direction with respect to the second straight line.

According to the present embodiment, the first main part 21a and the second main part 21b are provided so as to (i) overlap the polarization axes of the polarizing plates which are in contact with the array substrate 1 and the counter substrate 2, respectively or (ii) overlap the polarization axes of the polarizing plates which are in contact with the counter substrate 2 and the array substrate 1, respectively. The directions, in which the respective plurality of branch parts 22a through 22d extend, need only be determined according to desired directions in which the liquid crystal molecules are tilted while a voltage is being applied. In other words, the directions, in which the liquid crystal molecules are to be tilted, are determined by the directions in which the plurality of branch parts 22a through 22d extend.

The plurality of branch parts 22a through 22d preferably extend, for example, at respective angles of 45°, 135°, 225°, and 315°, where (i) an angle at which a left part of the first straight line extends is 0° and (ii) an angle at which a right part of the first straight line extends is 180°. However, the angles of the branch parts 22a through 22d are not particularly limited to such. As described above, the first and second main parts 21a and 21b are provided so as to overlap one of the polarization axes of the pair of polarizing plates. Therefore, in a case where the branch parts 22a through 22d are formed in such respective angles, the liquid crystal molecules are to be tilted in four directions, i.e., each at approximately 45° angles to one of the polarization axes of the pair of polarizing plates. Since the amount of light to be absorbed by the polarizing plates is thus reduced, it is possible to increase the transmissivity of the liquid crystal display panel 10.

(Pattern of Pixel Electrode 30)

On the other hand, the pixel electrode 30 provided in the second pixel is similar to the pixel electrode 20 provided in the first pixel in that a first main part 31a, a second main part 31b, and a plurality of branch parts 32a through 32d are formed by presence of a plurality of slits. However, the pixel electrode 30 is different from the pixel electrode 20 in that the pixel electrode 30 further includes, as a region on which a spacer member is to be provided, a solid electrode 33.

As illustrated in (b) of FIG. 1, the first main part 31a is provided on a first straight line that connects end parts of the pixel electrode 30 via a center part of the pixel electrode 30 (straight line illustrated by “A” in (b) of FIG. 1). The second main part 31b is provided on a second straight line that (i) is perpendicular to the first straight line and (ii) connects end parts of the pixel electrode 30 via the center part of the pixel electrode 30 (straight line illustrated by “B” in (b) of FIG. 1).

The term “solid electrode” herein refers to a region on which an electrode is formed without any inch to spare. In other words, it is a region which (i) is part of where slits are formed in a pixel electrode 20 and (ii) is made continuous by presence of an electrode (for example, a region enclosed with a dotted line shown by “X” in (b) of FIG. 1). Note that, in (b) of FIG. 1, the first main part 31a and the second main part 31b each appear to be cut apart by the presence of the solid electrode 33. However, main parts 31a and 31b of a pixel electrode 30 herein refer to an electrode provided on a straight line A and an electrode provided on a straight line B, respectively, although part of the main parts 31a and 31b is a solid electrode.

The plurality of branch parts 32a through 32d (i) are present within respective four regions into which the pixel electrode 30 is divided by the first main part 31a and the second main part 31b and (ii) extend, in respective four directions, from at least one of the first main part 31a and the second main part 31b to end parts of the pixel electrode 30. Note, however, that, in the region on which the solid electrode 33 is provided, branch parts 32a through 32d extend from at least one of the first main part 31a and the second main part 31b while the solid electrode 33 is situated on top of corresponding parts of the branch parts 32a through 32d.

According to the second pixel electrode 30, the region on which a spacer member 4 is provided is thus configured to be a solid electrode. This makes it possible to prevent display defects.

In a case of, for example, a display panel which functions as a touchscreen, a pixel electrode receives, via a corresponding spacer member, a force which is applied each time a screen is touched. In so doing, if such a pixel electrode, provided so as to be in contact with a spacer member, is formed, for example, in a fine pattern as is the first pixel electrode 20, then the pixel electrode will be subject to damages such as electric disconnection. According to the liquid crystal display panel 10 of the present embodiment, as described above, no spacer member 4 is provided in any first pixel but a spacer member 4 is provided in each second pixel. Note, however, that such a spacer member 4 is provided on a part of each of the pixel electrodes 30 which part is a solid electrode. This prevents electric disconnection of each pixel electrode 30 even when it receives a pressing force via a corresponding spacer member 4, and therefore makes it possible to maintain reliability of the display panel.

According to the present embodiment, the solid electrode 33 has an octagonal shape expanding outwards so that edges of the octagonal shape are substantially the same distance away from the center part of the pixel electrode 30. Note, however, that the shape and position of the solid electrode 33 are not particularly limited, provided that the solid electrode 33 falls on the center part of the pixel electrode 30. For example, the solid electrode 33 can have (i) a shape matching the shape of a counter surface of a corresponding spacer member 4 which counter surface faces the pixel electrode 30 or (ii) a laterally-long shape extending to both lateral end parts of the first main part 31a. Note, however, that the solid electrode 33 preferably has a counter surface whose area is one size larger than that of the counter surface of the spacer member 4. This is due to the following consideration: For example, in some cases, the array substrate 1 and the counter substrate 2 are shifted from each other when combined together, and consequently the spacer member 4 becomes shifted as well. Since the solid electrode 33 is one size larger in area than the counter surface of the spacer member 4, it is possible to lower the possibility of the spacer member 4 coming into contact with a fine pattern of the pixel electrode 30 even if the spacer member 4 is somewhat shifted. This makes it possible to suitably prevent electric disconnection of the second pixel electrode 30.

[Alignment Status of Liquid Crystal Molecules]

The following description will discuss a principle of how alignment of liquid crystal molecules is controlled in the liquid crystal display panel 10 of the present embodiment. According to the liquid crystal display panel 10, as has been described, (i) the alignment of the liquid crystal molecules in each of the first pixels is controlled by the pattern of a pixel electrode 20 and (ii) the alignment of the liquid crystal molecules in each of the second pixels is controlled by the pattern of a pixel electrode 30 and a spacer member 4.

(Alignment Control Around Slits)

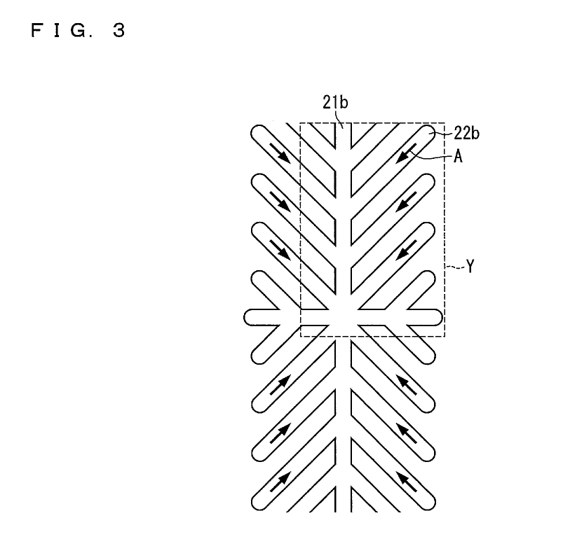

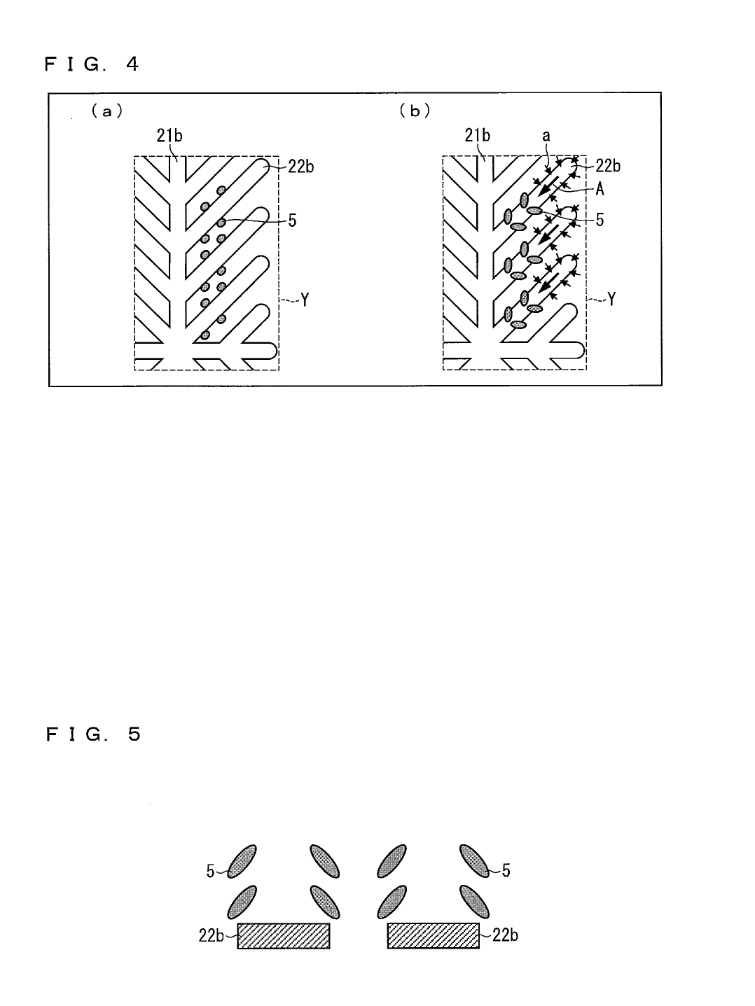

Alignment of liquid crystal molecules around the slits of the pixel electrode 20 will be first described below. FIG. 3 is a view illustrating orientations of liquid crystal molecules in the first pixel electrode 20. FIG. 4 is a view describing the alignment of liquid crystal molecules in a region Y enclosed with a dotted line illustrated in FIG. 3. FIG. 5 is a view illustrating an alignment status of the liquid crystal molecules when the liquid crystal molecules are oriented in the direction of an arrow A illustrated in FIG. 3.

The pixel electrode 20 has a plurality of slits. When a voltage is applied to the pixel electrode 20 having such a pattern, a force is applied in the vicinity of each of the slits, which force orients liquid crystals in the direction indicated by the arrow A, i.e., the force orients the liquid crystals toward the center part of the pixel electrode 20 away from the end parts of the branch parts 22a through 22d. The alignment status of the liquid crystals in such a state will be described below in detail.

FIG. 4 is an enlarged view of the region Y illustrated in FIG. 3. (a) of FIG. 4 illustrates the alignment status of the liquid crystal molecules when no voltage is applied. In this state, the liquid crystals are aligned vertically to both the array substrate 1 and the counter substrate 2. While a voltage is being applied to the pixel electrode 20, as illustrated in (b) of FIG. 4, (i) an alignment control force is applied from the respective end parts of the branch parts 22a through 22d toward respective rooting parts of the branch parts 22a through 22d and (ii) an alignment control force is applied from the slits to the branch parts 22b (see the forces indicated by a plurality of arrows denoted by “a”). The oblique direction indicated by the arrow A is an orientation resulted from composition of the forces. The liquid crystal molecules are tilted as illustrated in FIG. 5.

Specifically, alignment of liquid crystal molecules 5 is controlled so that liquid crystal molecules 5 are oriented in different directions via a slit between any adjacent branch parts 22b. Note that such an alignment control applies to each of the branch parts 22a, 22c, and 22d which are provided in the other segments. Specifically, liquid crystal molecules 5 are oriented in different directions via (i) a slit between any adjacent branch parts 22a, (ii) a slit between any adjacent branch parts 22c, and (iii) a slit between any adjacent branch parts 22d. Since such an alignment control is carried out in each of the four segments, the liquid crystal molecules 5 are consequently aligned in four different directions on the whole. This allows for an excellent alignment status in all the segments of a first pixel.

(Alignment Control by Spacer Member 4)

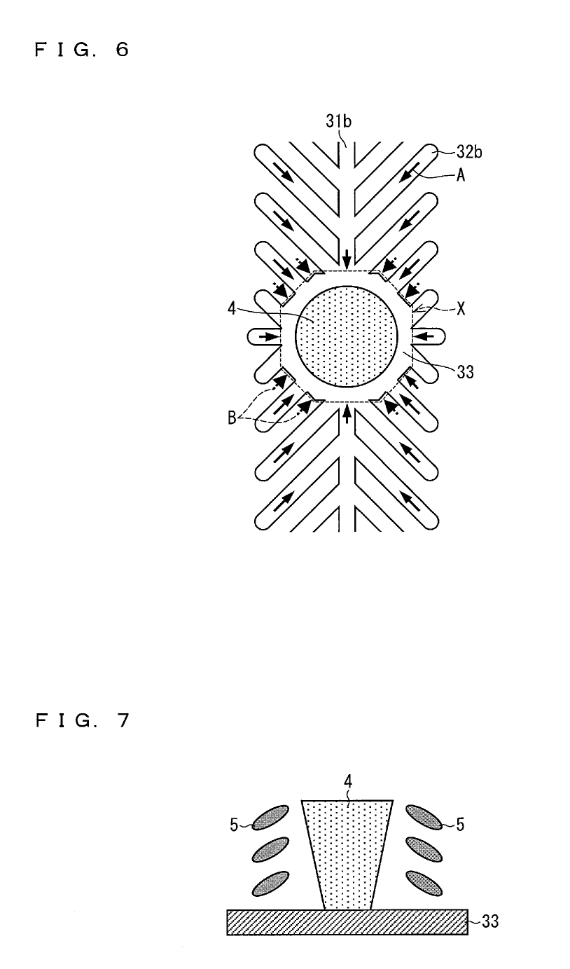

FIG. 6 is a view illustrating orientations of liquid crystal molecules in the second pixel electrode 30. FIG. 7 is a view illustrating an alignment status of liquid crystal molecules in the vicinity of the spacer member 4.

The pixel electrode 30 has the plurality of slits as does the pixel electrode 20. Therefore, alignment of liquid crystal molecules, which exist in regions where the slits are present, is controlled as in the case of the pixel electrode 20. In addition, alignment of liquid crystal molecules, which exist on the solid electrode 33 on which the spacer member 4 is provided, is controlled by the spacer member 4.

In other words, the spacer members 4 provided in the liquid crystal layer 3 affect the alignment of the liquid crystal molecules. Specifically, the spacer member 4 in the pixel electrode 30 serves as an obstacle, so that an alignment force (as indicated by an arrow B illustrated in FIG. 6) is applied from the branch parts 32a through 32d to the spacer member 4. Meanwhile, as in the case of the first pixel electrode 20, an alignment force is applied to the branch parts 32a through 32d from the respective end parts of the branch parts 32a through 32d to the center part of the pixel electrode 30. When a voltage is applied to such a pixel electrode 30, liquid crystal molecules 5 in the vicinity of the spacer member 4 are tilted in a fixed direction (see FIG. 7). According to the pixel electrode 30, the alignment of the liquid crystal molecules 5 in the vicinity of the solid electrode 33 are thus controlled by the spacer member 4.

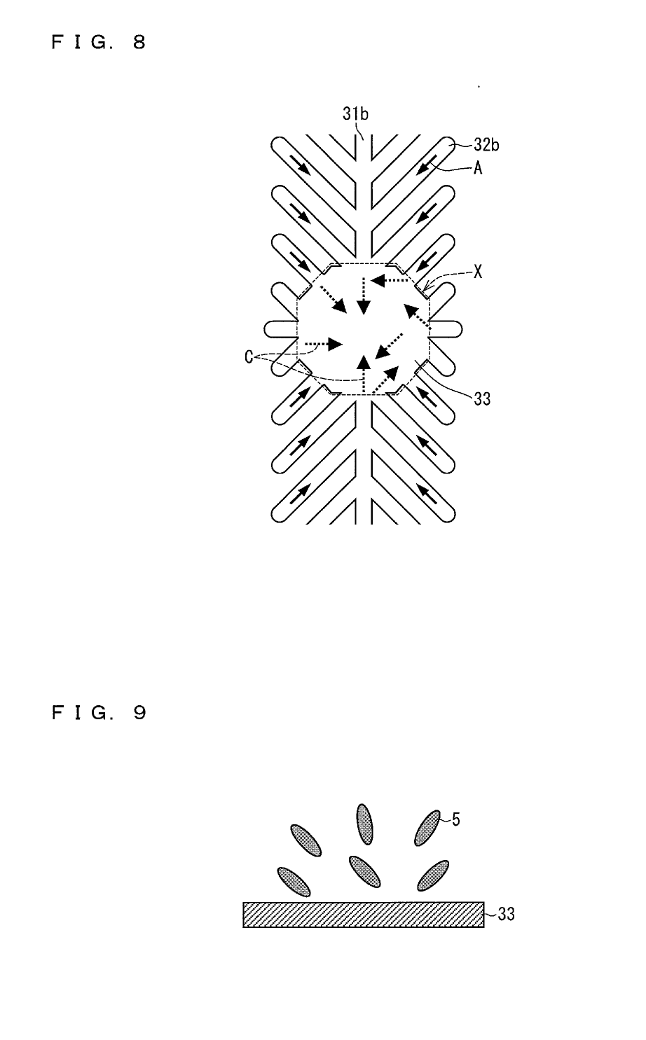

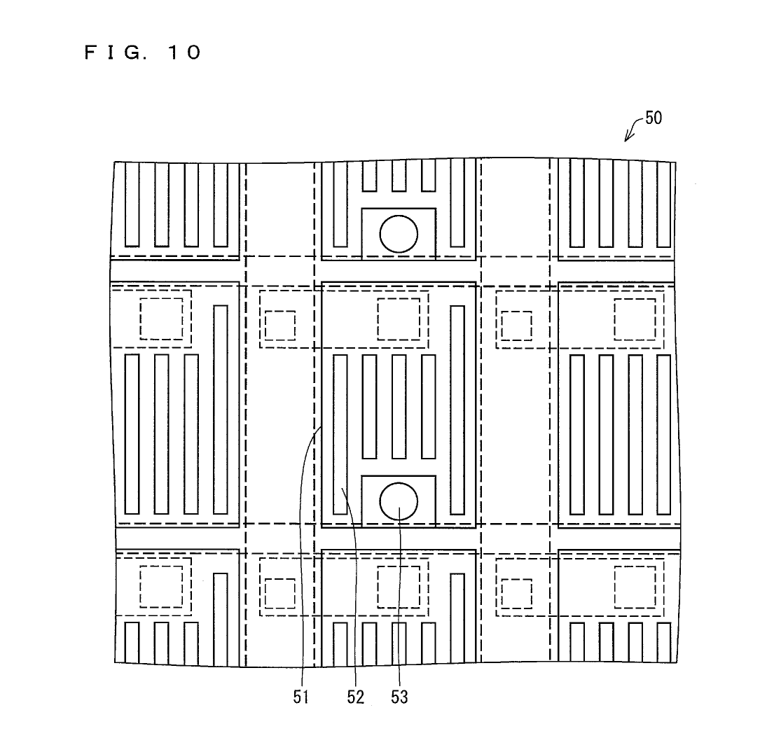

In contrast, if no spacer member 4 is provided on a solid electrode, then an alignment control is insufficient. Specifically, if a solid electrode is provided in a region where no spacer member 4 is provided, then alignment directions will be disordered as indicated by arrows C illustrated in FIG. 8. This results in an insufficient control of alignment of liquid crystal molecules 5 as illustrated in FIG. 9, and consequently causes display defects such as a noisy image. FIG. 8 is a view illustrating alignment directions at the solid electrode 33. FIG. 9 is a view illustrating an alignment status of the liquid crystal molecules 5 which exist on the solid electrode 33 illustrated in FIG. 8.

According to the second pixel electrode 30, however, (i) the alignment of the liquid crystal molecules 5, which exist in the region where the spacer member 4 is provided, is controlled by the spacer member 4 and (ii) the alignment of the liquid crystal molecules 5, which exist in regions where no spacer member 4 is provided, is controlled in the presence of the slits. In addition, the alignment of the liquid crystal molecules 5 in the vicinity of the spacer member 4 can also be controlled so that such liquid crystal molecules 5 are tilted in four directions since there is an alignment force applied from the end parts of the branch parts 32a through 32d in the vicinity of the solid electrode 33 toward the center part of the solid electrode 33. This allows for an excellent alignment status.

According to the liquid crystal display panel 10 of the present embodiment, a part of a pixel electrode without a spacer member 4 has a fine pattern with the presence of slits, as described above. This allows for a more stable control of liquid crystal alignment. Furthermore, the other part of the pixel electrode provided with a spacer member 4 is a solid electrode. This makes it possible to (i) prevent pixel defects as well as (ii) sufficiently control the alignment of liquid crystal molecules. Therefore, the liquid crystal display panel 10 of the present embodiment can realize excellent display.

Note that a liquid crystal display device including the liquid crystal display panel of the present invention is also encompassed in the technical scope of the present invention. Examples of such a liquid crystal display device encompass various display devices such as television, personal computer, mobile phone, mobile electronic device, and mobile gaming device.

The present invention is not limited to the description of the embodiments, but can be altered in many ways by a person skilled in the art within the scope of the claims. An embodiment derived from a proper combination of technical means disclosed in different embodiments is also encompassed in the technical scope of the present invention.

### Summary of Embodiment

It is preferable to thus configure a liquid crystal display panel in accordance with the embodiment of the present invention such that each of the solid electrodes is larger in area than a counter surface of a corresponding one of the spacer members, which counter surface faces a corresponding one of the second pixel electrodes.

According to the configuration, the solid electrode has a surface area larger than that of the counter surface of the spacer member. This is due to the following consideration:

For example, in some cases, the array substrate and the counter substrate are shifted from each other when combined together, and consequently the spacer member becomes shifted as well. Since the solid electrode is larger in area than the counter surface of the spacer member, it is possible to lower the possibility of the spacer member coming into contact with a fine pattern of the second pixel electrode even if the spacer member is somewhat shifted. This makes it possible to suitably prevent electric disconnection of the second pixel electrode.

It is more preferable to configure the liquid crystal display panel in accordance with the embodiment of the present invention such that a center axis of each of the spacer members falls on a part of corresponding one of the second pixel electrodes, which part is closer to a center part of the corresponding one of the second pixel electrodes than to any end part of the corresponding one of the second pixel electrodes.

If, for example, a spacer member is provided at an end part of a pixel electrode, alignment directions of a pixel may become disordered. According to the configuration, therefore, the spacer member is provided in the proximity of the center part of the pixel electrode. This prevents disorderly pixel alignment, and therefore allows for excellent pixel alignment.

It is more preferable to configure the liquid crystal display panel in accordance with the embodiment of the present invention such that: liquid crystal molecules contained in the liquid crystal layer are arranged so that major axes of the respective liquid crystal molecules are each (i) vertical to the substrate while no voltage is applied and (ii) parallel to the substrate while a voltage is being applied; and the plurality of branch parts extend in directions so that the liquid crystal molecules are aligned in four directions in each of the first pixels and the second pixels while a voltage is being applied.

According to the configuration, the plurality of branch parts provided in the pixel electrodes in the first and second pixels extend in direction such that liquid crystal molecules are aligned in four directions in each pixel when voltage is applied. In other words, the liquid crystal molecules, which are present in four regions into which each pixel is divided, are controlled to be aligned in four directions so as to be tilted in respective four directions. This allows display characteristics to be enhanced.

The embodiments and the concrete examples, which have been discussed in the detailed description, are illustrative only, which should not be narrowly interpreted within the limits of such embodiments and concrete examples, but are rather meant to be applied in any variations within the spirit of the present invention, provided that such variations do not exceed the scope of the patent claims set forth below.

### INDUSTRIAL APPLICABILITY

A liquid crystal display panel of the present invention is suitable for various display devices such as television, personal computer, mobile phone, mobile electronic device, and mobile gaming device.

### REFERENCE SIGNS LIST

1 Array substrate (substrate)
2 Counter substrate
3 Liquid crystal layer
4 Spacer member
10 Liquid crystal display panel
20 First pixel electrode
30 Second pixel electrode

1. A liquid crystal display panel comprising:
a substrate on which first pixels and second pixels are provided;
a counter substrate provided so as to face the substrate;
a liquid crystal layer sandwiched between the substrate and the counter substrate; and
a plurality of spacer members for maintaining a fixed distance between the substrate and the counter substrate,
no spacer member being provided in each of the first pixels, and the first pixels including respective first pixel electrodes, and the plurality of space members being provided in the respective second pixels, and the second pixels including respective second pixel electrodes,
the first pixel electrodes each having
a first main part provided on a first straight line which connects two end parts of the first pixel electrode via the center part of the first pixel electrode,
a second main part provided on a second straight line which is perpendicular to the first straight line and which connects two end parts of the first pixel electrode via the center part of the first pixel electrode, and
a plurality of branch parts which (a) are present within regions into which the first pixel electrode is divided by the first main part and the second main part and (b) extend, in respective directions relative to the regions, from at least one of the first main part and the second main part to end parts of the first pixel electrode,
the second pixel electrodes each having
a first main part provided on a first straight line which connects two end parts of the second pixel electrode via the center part of the second pixel electrode,
a second main part provided on a second straight line which is perpendicular to the first straight line and which connects two end parts of the second pixel electrode via the center part of the second pixel electrode,
a plurality of branch parts which (I) are present within regions into which the second pixel electrode is divided by the first main part and the second main part and (II) extend, in respective directions relative to the regions, from at least one of the first main part and the second main part to end parts of the second pixel electrode, and
a region (A) which includes the center part of the second pixel electrode, (B) which is a solid electrode, and (C) on which a corresponding one of the plurality of spacer members is provided.

2. The liquid crystal display panel as set forth in claim 1, wherein each of the solid electrodes is larger in area than a counter surface of a corresponding one of the spacer members, which counter surface faces a corresponding one of the second pixel electrodes.

3. The liquid crystal display panel as set forth in claim 1, wherein each of the spacer members is provided so that its center axis falls on a part of corresponding one of the second pixel electrodes, which part is closer to a center part of the corresponding one of the second pixel electrodes than to any end part of the corresponding one of the second pixel electrodes.

4. The liquid crystal display panel as set forth in claim 1, wherein:
liquid crystal molecules contained in the liquid crystal layer are arranged so that major axes of the respective liquid crystal molecules are each (i) vertical to the substrate while no voltage is applied and (ii) parallel to the substrate while a voltage is being applied; and
the plurality of branch parts extend in directions so that the liquid crystal molecules are aligned in four directions in each of the first pixels and the second pixels while a voltage is being applied.

5. A liquid crystal display device comprising:
a liquid crystal display panel as set forth in claim 1.
